(19) United States
(12) Patent Application Publication
(10) Pub. No.: US 2017/0316537 A1
(43) Pub. Date: Nov. 2, 2017

(54) SYSTEM FOR AND METHOD OF SENSING AND RESPONDING TO EMERGENCIES IN A VENUE

(71) Applicant: SYMBOL TECHNOLOGIES, LLC, LINCOLNSHIRE, IL (US)

(72) Inventors: MARK E. DRZYMALA, ST. JAMES, NY (US); EDWARD D. BARKAN, MILLER PLACE, NY (US); DARRAN M. HANDSHAW, SOUND BEACH, NY (US)

(21) Appl. No.: 15/144,269

(22) Filed: May 2, 2016

(51) Int. Cl. G06Q 90/00; G08B 7/06; G06Q 10/06; G08B 13/24; G06K 19/07

(52) U.S. Cl. CPC G06Q 90/20; G08B 13/2494; G06K 19/0728; G06Q 10/063112; G08B 7/066

(57) ABSTRACT

A sensing unit mounted at a venue can capture images of targets in the venue, and/or can sonically locate targets in the venue, and/or can read targets configured as radio frequency (RF) identification (RFID) tags in the venue. A control arrangement recognizes whether at least one of the targets is indicative of an emergency in the venue, and automatically executes a remedial action in response to the recognized emergency.

### BACKGROUND OF THE INVENTION

The present disclosure relates generally to a system for, and a method of, sensing and responding to emergencies, such as situations requiring medical assistance, security threats requiring police officer assistance, fires requiring firefighter assistance, and like dangers requiring help from first responders, in a venue, especially a retail venue.

Businesses, especially retailers that deal with the public, might, from time to time, be exposed to emergencies. For example, a customer or employee might suddenly become ill and need immediate medical assistance, or might be exposed to violence during the course of a robbery, retail theft, or like security threat, or might be exposed to harm and injury from a fire on the premises. To deter shoplifting, many businesses hire security guards, who, together with any salespeople, are also theoretically available to respond to any such emergency. Yet, a security guard/salesperson may not be qualified to respond to a medical situation, or may simply not be present at the scene of the emergency, or may be ineffective in responding to the emergency. Hence, although many businesses would like to create a safe environment for their customers and employees, such people are often not adequately protected. This might lead, for example, after negative publicity about an emergency not favorably resolved, to some customers not frequenting the retailer and negatively impacting the retailer's business.

Accordingly, it would be desirable to safeguard the public and employees by swiftly and automatically responding to emergencies, especially by employing equipment that many businesses already have on hand for locating and tracking product inventories.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective, schematic view, as seen from above, of a system for sensing and responding to emergencies in a retail venue by employing an overhead sensing unit in accordance with the present disclosure.

FIG. 2 is a perspective view, as seen from below, of a preferred embodiment of the sensing unit of FIG. 1.

FIG. 3 is an elevational view of the unit of FIG. 2.

FIG. 4 is a bottom plan view of the unit of FIG. 2, and showing a bottom access door in a closed position.

FIG. 5 is a perspective view of the unit of FIG. 2, and showing the bottom access door in an open position.

FIG. 6 is a broken-away, enlarged, sectional view of the unit of FIG. 2, and showing the interior of the unit.

FIG. 7 is a block diagram showing the electrical connections among various built-in systems mounted in the interior of the unit of FIG. 2.

FIG. 8 is a block diagram depicting electrical connections between various components, as well as diagrammatically depicting the operation, of the system.

FIG. 9 is a flow chart of a method of sensing and responding to emergencies in a retail venue in accordance with the present disclosure.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One aspect of the present disclosure relates to a system for sensing and responding to emergencies in a venue. The system has at least one sensing unit mounted at the venue, preferably at an overhead position, for detecting targets. The sensing unit includes a camera assembly for capturing images of the targets in the venue, and/or a locationing assembly for sonically locating the targets in the venue, and/or a radio frequency (RF) identification (RFID) tag reader assembly for reading the targets configured as RFID tags in the venue. A control arrangement is operatively connected to the sensing unit, and is operative to recognize whether at least one of the targets detected by at least one of the assemblies is indicative of an emergency in the venue, and to automatically execute a remedial action in response to the recognized emergency.

The locationing assembly includes an audio receiver or microphone for receiving a sound in the venue. The control arrangement includes a processor for processing the received sound, and for generating an emergency alert signal when the processed sound is indicative of the emergency. The camera assembly includes a camera for capturing a visual image in the venue. The processor is also operative for processing the received visual image, and for generating an emergency alert signal when the processed visual image is indicative of the emergency. The RFID assembly includes a tag reader for reading an RFID tag. The processor is further operative for processing the RFID tag, and for generating an emergency alert signal when the processed RFID tag is indicative of the emergency. The control arrangement is operative for generating an emergency alert signal in response to the recognized emergency, and for transmitting the emergency alert signal to emergency or first responder personnel and/or emergency equipment to take the remedial action.

One or more of these assemblies may be operated, during an inventorying mode of operation, to locate and track products in the venue by locating and tracking the targets. Many businesses already have such sensing units installed at the venue for locating and tracking product inventories. In accordance with this aspect of the disclosure, the existing sensing units are modified and configured for a different purpose, i.e., to sense and respond to emergencies during a security mode of operation. Thus, the public and employees are provided with a safer environment and are better protected than heretofore.

A method of sensing and responding to emergencies in a venue, in accordance with another aspect of the present disclosure, is performed by detecting targets with a sensing unit mounted at the venue; by configuring the sensing unit with at least one of a camera assembly for capturing images of the targets in the venue, a locationing assembly for sonically locating the targets in the venue, and a radio frequency (RF) identification (RFID) tag reader assembly for reading the targets configured as RFID tags in the venue; by recognizing whether at least one of the targets detected by at least one of the assemblies is indicative of an emergency in the venue; and by automatically executing a remedial action in response to the recognized emergency.

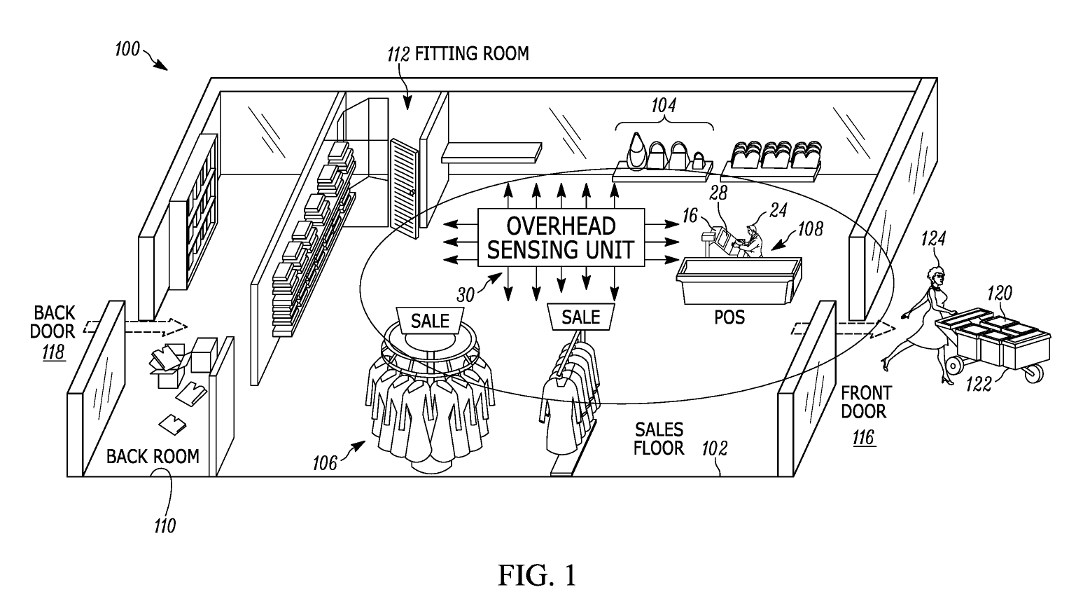

Turning now to the drawings, FIG. 1 schematically depicts a system for sensing and responding to emergencies, as described below, including, but not limited to, the theft of items 120, especially retail items, from a retail venue 100 having a retail sales floor 102 on which a point-of-sale (POS) station 108 is provided with a host control arrangement or network server 16, and an interface 28 that is operated by a retail employee 24. The retail venue 100 typically has a fitting room 112 and a backroom 110 away from the sales floor 102. It will be understood that, in many applications, the server 16 is preferably located in the backroom 110. A front door 116 provides access to the sales floor 102. A back door 118 provides access to the back room 110 to which cartons 114 of items may be moved and stored. As described below, in a security mode of operation, the system of this invention is intended to recognize and to automatically respond to emergencies, such as the theft of the items 120 being removed without authorization from the venue 100, for example, by being wheeled out on a shopping cart 122 by a customer 124 through a doorway, e.g., the front door 116, or the back door 118, without first completing a retail transaction for the items 120 by paying for the items 120 at the POS station 108. Although a retail venue has been illustrated, it will be understood that many other different types of venues can benefit from the system of this disclosure.

The system includes at least one overhead sensing unit 30 for sensing targets associated with the items 120 over a coverage range that preferably extends over the doorway, e.g., the front door 116. To simplify FIG. 1, only one sensing unit 30 has been illustrated as being preferably located overhead on the ceiling above the sales floor 102 and remote from any doorway, such as the front door 116 and/or the back door 118. It will be understood that more than one sensing unit 30 could be, and preferably are, deployed overhead in the venue 100, and not necessarily deployed on the ceiling. Advantageously, a plurality of sensing units 30 can be installed every twenty to eighty feet or so in a square grid. As described below, many different types of targets, e.g., items 120, can be sensed by each sensing unit 30. Such items 120 include, for example, the various retail products or items being offered for sale on the floor 102, e.g., clothes 106, handbags 104, etc., that are arranged on shelves, hangers, racks, etc. As described below, each such item is preferably tagged with a radio frequency (RF) identification (RFID) tag, preferably a passive RFID tag for cost reasons. It will be further understood that, in some applications, for example, in a warehouse venue, each RFID tag may be associated with a pallet or contained in the carton 114 for multiple products.

The server 16 comprises one or more computers and is in wired, wireless, direct, or networked communication with the interface 28 and with each sensing unit 30. The interface 28 provides a human/machine interface, e.g., a graphical user interface (GUI), that presents information in pictorial and/or textual form (e.g., representations of the RFID-tagged items 104, 106) to the employee 24, and to initiate and/or alter the execution of various processes that may be performed by the server 16. The server 16 and the interface 28 may be separate hardware devices and include, for example, a computer, a monitor, a keyboard, a mouse, a printer, and various other hardware peripherals, or may be integrated into a single hardware device, such as a mobile smartphone, or a portable tablet, or a laptop computer. Furthermore, the user interface 28 can be in a smartphone, or tablet, etc., while the server 16 may be a local computer, or can be remotely hosted in a cloud server. The server 16 may include a wireless RF transceiver that communicates with each sensing unit 30. For example, Wi-Fi and Bluetooth® are open wireless standards for exchanging data between electronic devices.

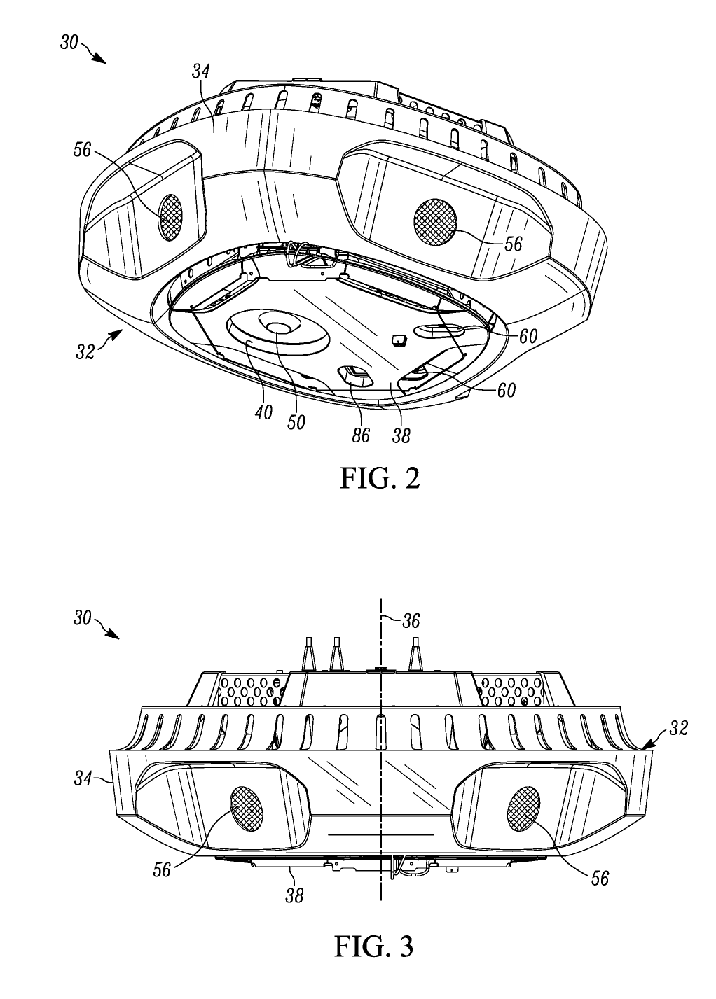

A preferred embodiment of each sensing unit 30 is depicted in FIGS. 2-7. Each unit 30 has a generally circular, hollow, common housing 32 mounted at a single overhead location in a zone of the venue 100. Preferably, an upright, vertical post 80 extends downwardly from the ceiling, and a lower end of the post 80 is connected to an apertured plate or cage 82 that is attached to a bracket 84 that, in turn, is connected to the housing 32. The housing 32 has an outer wall 34 bounding an upright, vertical axis 36 and a bottom wall, which is configured as a hinged access door 38. The door 38 has a generally circular opening 40. The housing 32 supports a plurality of electrically-powered sensor modules operative for sensing and identifying targets associated with the items in the venue 100, and for generating and capturing target data indicative of the items.

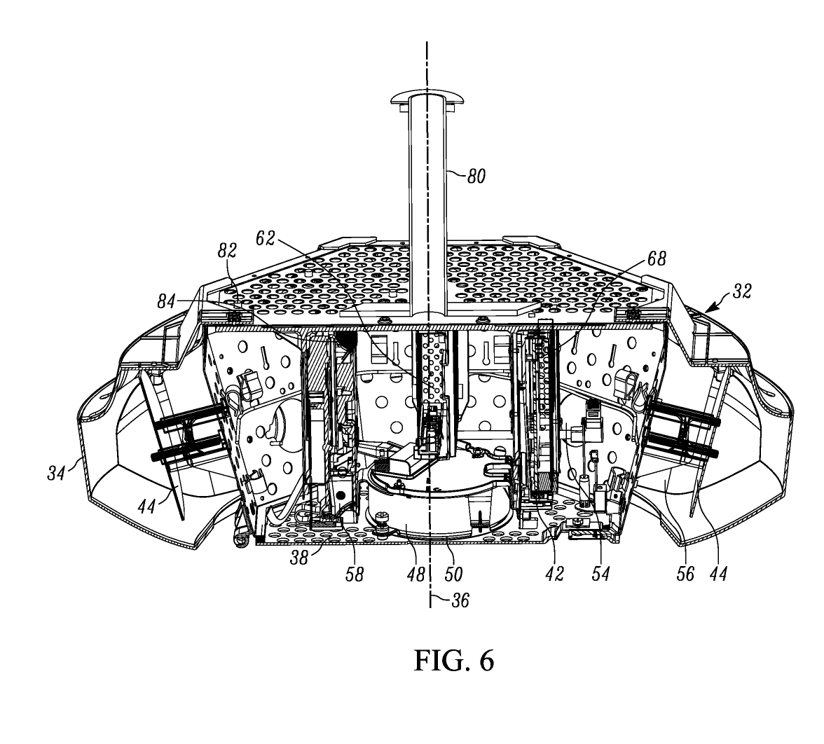

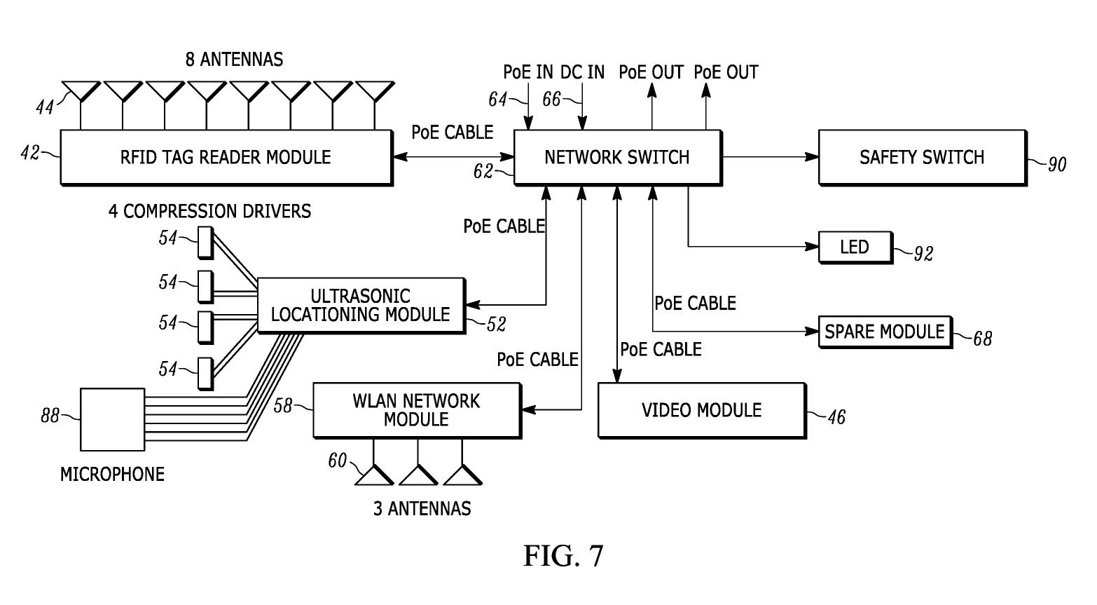

As best shown in FIG. 7, one of the sensor modules is a component of an RFID reader assembly and constitutes an RFID tag reader module 42 that is interchangeably mounted within the housing 32, for reading targets configured as RFID tags in the venue 100 over its coverage range. The RFID module 42 includes control and processing electronics that are operatively connected to a plurality of RFID antennas 44, which are energized by the RFID module 42 in a firing order. The RFID module 42 includes an RF transceiver operated, under the control of the server 16, to form and steer an interrogating RF beam across, and interrogate and process the payloads of, any RFID tags that are in its coverage range. It will be understood that there may be thousands of RFID tags in the venue 100. The RFID antennas 44 receive a return RF beam from the interrogated tag(s), and the RFID module 42 decodes an RF signal from the return RF beam, under the control of the server 16, into decoded data. The decoded data, also known as a payload or captured target data, can denote a serial number, a price, a date, a destination, a location, other attribute(s), or any combination of attributes, and so on, for the tagged item. As best shown in FIG. 6, the RFID antennas 44 are mounted inside the housing 32 and are arranged, preferably equiangularly spaced apart, about the upright axis 36. The outer wall 34 covers the RFID antennas 44 and acts as a radome to protect the RFID antennas 44. The outer wall 34, as well as the housing 32, is constituted of a material, such as plastic, through which RF signals can readily pass.

As also shown in FIG. 7, another of the sensor modules is a component of a camera assembly and constitutes a video module 46 interchangeably mounted within the housing 32, and operatively connected to a camera 48, also mounted within the housing 32. The video module 46 includes camera control and processing electronics for capturing either still images, or a video stream of images, of targets, also known as captured target data, in the zone of the venue 100 over an imaging field of view at a frame rate and a resolution. Preferably, the frame rate and/or the resolution are adjustable. The targets can, for example, be the aforementioned RFID-tagged items, and can even be people, such as the employee 24 or the customer 124, under surveillance by the camera 48. The camera 48 has a lens 50 that faces, and is optically aligned with, the opening 40 in the access door 38. The camera 48 is advantageously a high-bandwidth, moving picture expert group (MPEG) compression camera that can sense visible light and/or infrared (IR) light.

As further shown in FIG. 7, still another of the sensor modules is a component of a locationing assembly and constitutes an ultrasonic locationing module 52 interchangeably mounted within the housing 32, for locating targets configured as mobile devices in the venue 100 by transmitting and receiving ultrasonic energy between the ultrasonic locationing module 52 and the mobile devices. The mobile devices can be handheld RFID tag readers, handheld bar code symbol readers, smartphones, tablets, watches, computers, radios, or the like, each device being equipped with a transducer, such as a microphone. The mobile device can also be the shopping cart 122, or any like freight moving device, for moving the items. The locationing module 52 includes control and processing electronics operatively connected to a plurality of compression drivers 54 and, in turn, to a plurality of ultrasonic transmitters, such as voice coil or piezoelectric speakers 56. The ultrasonic speakers 56 are preferably mounted on the outer wall 34 and are arranged, preferably equiangularly spaced apart, about the upright axis 36. The ultrasonic speakers 56 are driven by the locationing module 52 in a drive order. A feedback microphone 88 may also be mounted on the outer wall 34.

As still further shown in FIG. 7, still another of the modules may be a component of a communications assembly and constitutes a wireless local area network (WLAN) communications module 58 interchangeably mounted within the housing 32, for wireless communication over a network at the venue 100. The communications module 58 includes control and processing electronics that are operatively connected to a plurality of WLAN antennas 60 that are mounted, and spaced apart, on the housing 32. The communications module 58 serves as a Wi-Fi access point for transmitting and receiving wireless communications throughout the venue 100. Wi-Fi is an available wireless standard for wirelessly exchanging data between electronic devices, thereby establishing a local area network in the venue.

Each ultrasonic speaker 56 periodically transmits ultrasonic ranging signals, preferably in short bursts or ultrasonic pulses, which are received by the microphone on the mobile device. The microphone determines when the ultrasonic ranging signals are received. The communications module 58 advises the ultrasonic locationing module 52 when the ultrasonic ranging signals were received. The locationing module 52, under the control of the server 16, directs all the speakers 56 to emit the ultrasonic ranging signals in the drive order such that the microphone on the mobile device will not receive overlapping ranging signals from the different speakers. The flight time difference between the transmit time that each ranging signal is transmitted and the receive time that each ranging signal is received, together with the known speed of each ranging signal, as well as the known and fixed locations and positions of the speakers 56 on each sensing unit 30, are all used to determine the position of the microphone mounted on the mobile device, and, in turn, the position of the mobile device, also known as captured target data, using a suitable locationing technique, such as triangulation, trilateration, multilateration, etc.

A power and data distribution system is employed for transmitting network control data and electrical power to the sensor modules 42, 46, 52, and for transmitting the captured target data away from the sensor modules 42, 46, 52. The power and data distribution system includes a networking control switch 62 mounted within the housing 32, an exterior power and data cable, preferably a Power-over-Ethernet (PoE) cable, connected between each unit 30 and the server 16, and a plurality of interior PoE cables each connected between a respective module 42, 46, 52, 58 and the networking control switch 62. Each PoE cable connected to the modules 42, 46, 52 transmits the electrical power and transmits the control data thereto from the networking control switch 62, and transmits the target data away from the respective module 42, 46, 52 to the networking control switch 62. The PoE cable connected to the communications module 58 transmits the electrical power and transmits the control data thereto from the networking control switch 62, and transmits communications data away from the communications module 58 back to the server 16.

The exterior PoE cable is connected between a power source (not illustrated) and an input port 64 on the networking control switch 62. An optional DC power line 66 can be connected to the networking control switch 62. A spare module 68 can be accommodated within the housing 32. The spare module can be another sensor module, or, advantageously, can be another communications module operating under a different protocol, such as the Bluetooth® protocol or the ultra wideband protocol.

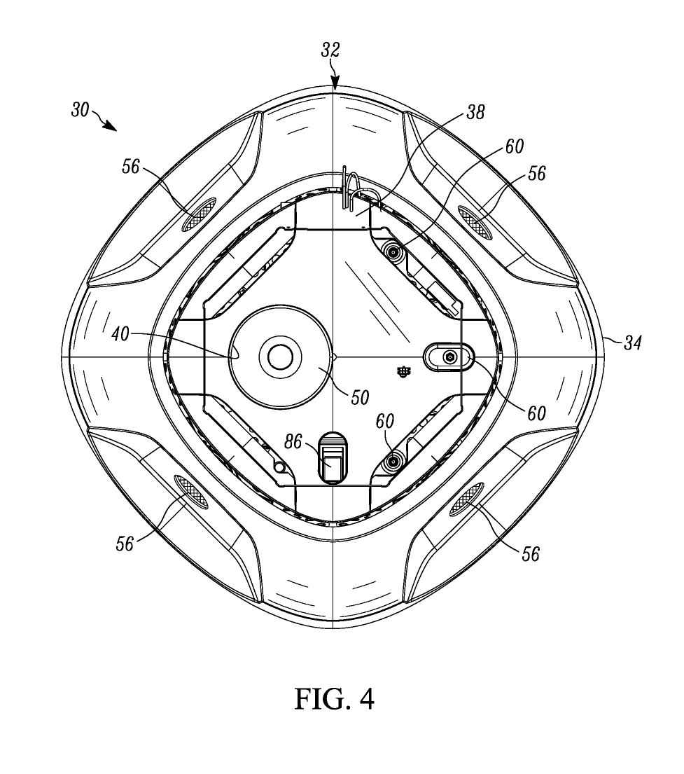

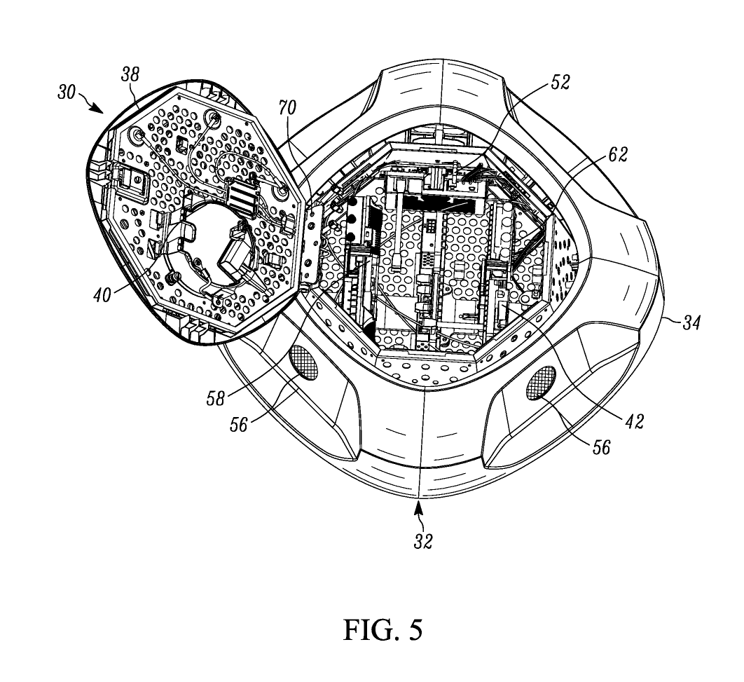

The aforementioned access door 38 is hinged at hinge 70 to the housing 32 for movement between an open position (FIG. 5) and a closed position (FIG. 4). A slide switch 86 is moved to unlock the access door 38. In the open position shown in FIG. 5, the modules 42, 52, 58 are all accessible to be installed in the housing 32, or to be removed from the housing 32 and replaced with another module for maintenance and repair.

A safety switch 90 (see FIG. 7) senses the position of the door 38, and discontinues or cuts the electrical power to the modules when the door 38 is in the open position. An indicator 92, e.g., a light emitting diode (LED), visually signals that the electrical power has been cut off.

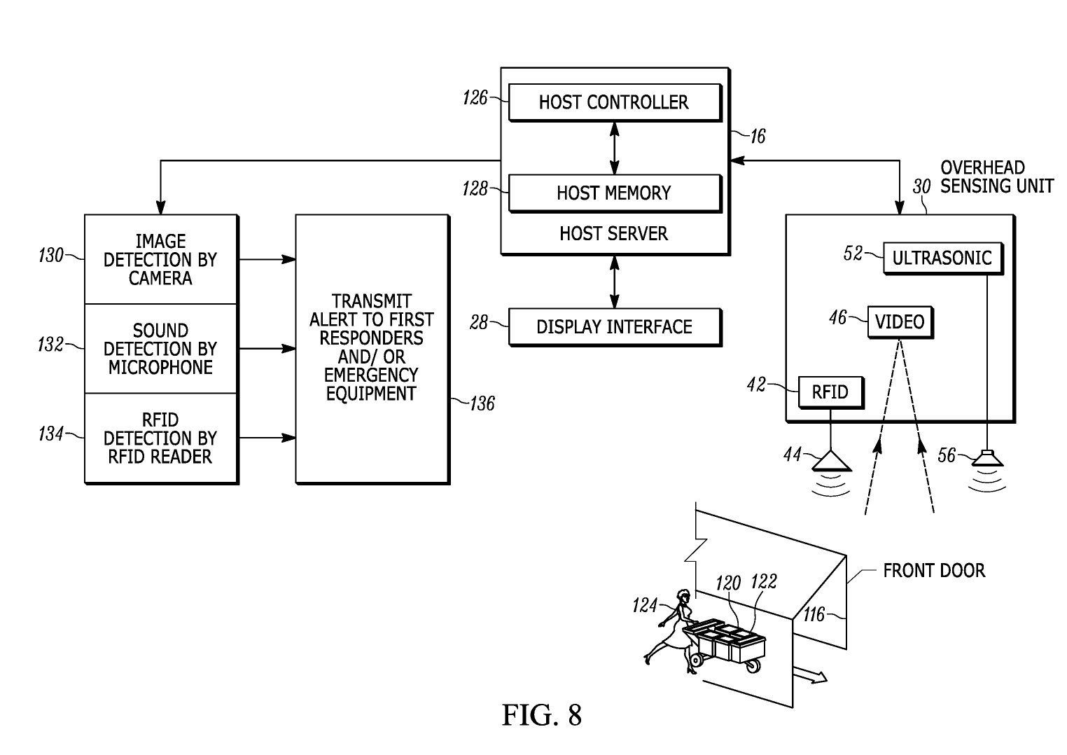

In normal operation, the customer 124 enters the venue 100, typically pushing the cart 122, selects items 120 to be purchased, places the selected items 120 in the cart 122, and goes to the POS station 108 to complete the transaction, for example, by paying for the items 120. At this time, the employee 24 removes and/or deactivates any RFID tags associated with the items 120. The server 16 registers each completed transaction at the POS station. Thus, as shown in FIG. 8, the server 16 includes a host controller 126 and a host memory 128. The host controller 126 records each transaction, generates a list of the completed transactions, and stores the list in the host memory 128. The list includes, among other things, a brief description of the item and an identifying number, such as its Universal Product Code (UPC). The customer 124 is now free to leave the venue 100 through the front door 116. The sensing unit 30 does not interfere with the customer's egress from the venue 100 in this scenario.

However, if the customer 124 bypasses the POS station 108 and attempts to leave the venue 100, then the sensing unit 30, whose coverage range extends over the front door 116, will sense the target, e.g., the RFID tag, associated with the item 120 that is passing through the front door 116, and will identify the item 120. This RFID tag was never removed or deactivated at the POS station 108 and, as a result, the removal of the associated item 120 from the venue 100 is unauthorized. The host controller 126 compares the identified item 120 with the items stored in the list, and will generate a theft or security alert when the identified item 120 is not on the list. The theft alert can be a visual and/or an audible signal generated, for example, on-board the overhead housing 32. The theft alert can also be a wireless communication sent via the communications module 58 to a telephone of a security guard to take remedial action by intercepting the shoplifter.

As shown in FIG. 8, the sensing unit 30 includes the above-described RFID tag reader assembly having the RFID reader module 42 and the RFID antenna elements 44 for locating and tracking the RFID tags over a coverage range that extends over the front door 116. Thus, if the RFID tag reader assembly identifies an RFID tag at the front door 116 for an item that is not on the list, then the host controller 126 will generate the theft alert. RFID tag detection by the RFID tag reader assembly is depicted in FIG. 8 at block 134, and the remedial action is depicted at block 136.

As also shown in FIG. 8, the sensing unit 30 further includes the above-described camera assembly having the video module 42 with its camera 44 for capturing either still images, or a video stream of images, of the targets over an imaging field of view that extends over the over the front door 116. Thus, if the camera assembly identifies an item at the front door 116 that is not on the list, then the host controller 126 will generate the theft alert. The mounting of the camera 44 within the housing 32 is especially advantageous, because the camera 44 is substantially hidden from view.

As also shown in FIG. 8, the sensing unit 30 further includes the above-described locationing assembly having the locationing module 52 and speakers 56 for ultrasonically locating targets configured as mobile devices for moving the items over a route that extends through the front door 116. Thus, if the locationing assembly identifies a mobile device that is moving an item through the front door 116 that is not on the list, then the host controller 126 will generate the theft alert.

Each target can be located and tracked by an individual assembly, or preferably, at least two of the assemblies mutually cooperate with each other to accurately locate and track the targets. For example, the RFID assembly may determine the general location or neighborhood of the tag with a certain level of accuracy, and the video assembly may determine the location of the tag with a higher or finer level of accuracy by locating the person who is holding or moving the tag. As another example, the ultrasonic locationing assembly may determine the general location or neighborhood of the mobile device with a certain level of accuracy, and the communications assembly may determine the location of the mobile device with a higher or finer level of accuracy by advising the ultrasonic locationing module when the ultrasonic energy was actually received by the mobile device. As still another example, all the assemblies may cooperate with one other to locate the target with a high degree of precision.

As previously mentioned, the system disclosed herein is not limited to deterring theft, but can sense and respond to a host of other emergencies. For example, if an employee or a customer 124 suddenly becomes ill and falls down, then the camera 44 can image the generally horizontal position of the person, and the server 16 can recognize the horizontal position as one requiring medical assistance, and can then generate and transmit an emergency alert signal, for example, by wireless communication via the communications module 58, to emergency personnel, e.g., an ambulance or hospital, to take remedial action. In the event of an armed robbery, the camera 44 can image the presence of a firearm, and the server 16 can recognize the firearm as one requiring police officer assistance, and can then generate and transmit an emergency alert signal, for example, by wireless communication via the communications module 58, to police department or other security personnel to take remedial action. In the event of a fire, the IR camera 44 can image the presence of hot spots, and the server 16 can recognize the hot spots as one requiring firefighter assistance, and can then generate and transmit an emergency alert signal, for example, by wireless communication via the communications module 58, to fire department or other fire safety personnel to take remedial action. Image detection by the camera 44 is depicted in FIG. 8 at block 130, and the remedial action is depicted at block 136.

In addition to capturing visual images to detect emergencies, the system disclosed herein can sense sounds. For example, the microphone 88 can detect a voice crying “help”, or “fire”, or yells or shouts above a predetermined sound level, or like sounds, or can detect a gunshot sound, or can detect an audible “man-down” alert from a firefighter's Personal Alert Safety System (PASS) that indicates that a firefighter has stopped moving and is likely trapped, disabled, or otherwise in trouble. In response, the server 16 can recognize such sounds, and can then generate and transmit an emergency alert signal, for example, by wireless communication via the communications module 58, to police or fire departments or other first responders, or to store security personnel, to take remedial action. Sound detection by the microphone 88 is depicted in FIG. 8 at block 132, and the remedial action is depicted at block 136. The gunshot sound can also be detected by the ultrasonic locationing system.

In addition to communicating with first responders, the server 16 can also control emergency equipment. For example, the emergency alert signal can also be sent to close any installed door or window locks to seal any intruder inside the venue and prevent escape until help arrives, or to turn any lights off inside the venue to prevent or at least thwart any intruder escape, or to flash a strobe light to at least temporarily blind any intruder, or to immediately turn any fire sprinklers on, or to pilot a drone, for example, one carrying a camera, to spot and track any intruder in real time, or to release tear gas to attack the intruder, or like deterrent actions.

The remedial action can also include controlling each sensing unit 30 to make audible announcements. For example, the speaker 56 in the sensing unit 30 that is closest to the emergency could actively direct first responders to the site of the emergency by audibly announcing that “The fire is here!”, or that “The intruder is here!”, or that “The man down is here!”, or words of like import. The speakers 56 in the sensing units 30 that are further away from the emergency could actively guide first responders to the site of the emergency by audibly announcing that “The fire is this way!”, or that “The intruder is this way!”, or that “The man down is this way!” The speaker 56 in the sensing unit 30 that is closest to the emergency could actively thwart an intruder by audibly announcing “Hands in the air!”, or “Drop your weapon!”, or “Surrender, you are surrounded!”, or words of like import. Prerecorded voices can be used to emulate shouts of arriving police officers to help the intruder lose his/her confidence. The speaker 56 in the closest sensing unit 30 can be determined using a suitable locationing technique, such as triangulation, trilateration, multilateration, etc. Analogously, the IR camera 48 in the sensing unit 30 that is closest to the emergency and determined by triangulation could actively direct first responders to the site of the emergency by having its speaker 56 audibly announce that “The fire is here!”

The remedial action can also include controlling each sensing unit 30 to send a map, e.g., a snapshot, of the site of the emergency to a dispatch center and like emergency personnel. In this way, the first responders might see exactly where an emergency is occurring to better their response. This map could be continuously updated.

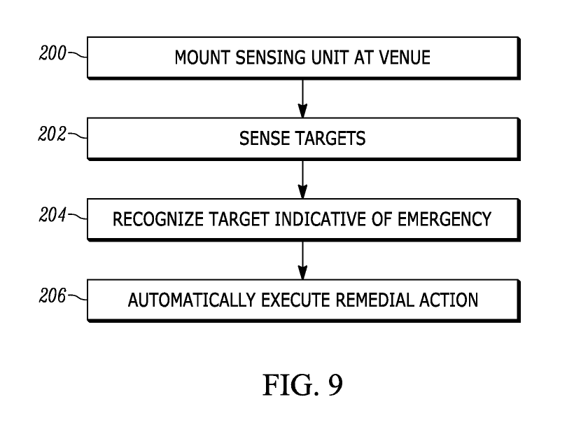

As shown in the flow chart of FIG. 9, the method of this disclosure is performed by mounting the sensing unit 30 at the venue 100 in step 200, by detecting targets in step 202, by recognizing that at least one of the targets is indicative of an emergency in the venue in step 204, and by automatically executing a remedial action in response to the recognized emergency in step 206.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A system for sensing and responding to emergencies in a venue, the system comprising:
a sensing unit mounted at the venue for detecting targets, the sensing unit including at least one of a camera assembly for capturing images of the targets in the venue, a locationing assembly for sonically locating the targets in the venue, and a radio frequency (RF) identification (RFID) tag reader assembly for reading the targets configured as RFID tags in the venue; and
a control arrangement operatively connected to the sensing unit, for recognizing whether at least one of the targets detected by at least one of the assemblies is indicative of an emergency in the venue, and for automatically executing a remedial action in response to the recognized emergency.

2. The system of claim 1, wherein the sensing unit includes a housing mounted at an overhead position in the venue.

3. The system of claim 1, wherein the locationing assembly includes an audio receiver for receiving a sound in the venue; and wherein the control arrangement includes a processor for processing the received sound, and for generating an emergency alert signal when the processed sound is indicative of the emergency.

4. The system of claim 1, wherein the camera assembly includes a camera for capturing a visual image in the venue; and wherein the control arrangement includes a processor for processing the received visual image, and for generating an emergency alert signal when the processed visual image is indicative of the emergency.

5. The system of claim 1, wherein the RFID assembly includes a tag reader for reading an RFID tag; and wherein the control arrangement includes a processor for processing the RFID tag, and for generating an emergency alert signal when the processed RFID tag is indicative of the emergency.

6. The system of claim 1, wherein the control arrangement is operative for generating an emergency alert signal in response to the recognized emergency, and for transmitting the emergency alert signal to at least one of emergency personnel and emergency equipment to take the remedial action.

7. The system of claim 1, wherein the sensing unit has a speaker for making an audible announcement at a site of the emergency in response to the recognized emergency.

8. The system of claim 7, wherein the audible announcement directs emergency personnel to the site of the emergency.

9. The system of claim 7, wherein the audible announcement is a deterrent warning for an intruder.

10. The system of claim 1, wherein the sensing unit has a camera for imaging a site of the emergency in response to the recognized emergency to create a map, and is further operative for sending the map to emergency personnel to guide the emergency personnel to the site of the emergency.

11. A method of sensing and responding to emergencies in a venue, the method comprising:
detecting targets with a sensing unit mounted at the venue;
configuring the sensing unit with at least one of a camera assembly for capturing images of the targets in the venue, a locationing assembly for sonically locating the targets in the venue, and a radio frequency (RF) identification (RFID) tag reader assembly for reading the targets configured as RFID tags in the venue;
recognizing whether at least one of the targets detected by at least one of the assemblies is indicative of an emergency in the venue; and
automatically executing a remedial action in response to the recognized emergency.

12. The method of claim 11, and mounting the sensing unit at an overhead position in the venue.

13. The method of claim 11, and receiving a sound with the locationing assembly, processing the received sound, and generating an emergency alert signal when the processed sound is indicative of the emergency.

14. The method of claim 11, and capturing a visual image with the camera assembly, and processing the received visual image, and generating an emergency alert signal when the processed visual image is indicative of the emergency.

15. The method of claim 11, and reading an RFID tag with the RFID assembly, processing the RFID tag, and generating an emergency alert signal when the processed RFID tag is indicative of the emergency.

16. The method of claim 11, and generating an emergency alert signal in response to the recognized emergency, and transmitting the emergency alert signal to at least one of emergency personnel and emergency equipment to take the remedial action.

17. The method of claim 11, and making an audible announcement at a site of the emergency in response to the recognized emergency.

18. The method of claim 11, and directing emergency personnel to the site of the emergency.

19. The method of claim 11, and announcing a deterrent warning for an intruder.

20. The method of claim 11, and imaging a site of the emergency in response to the recognized emergency to create a map, and sending the map to emergency personnel to guide the emergency personnel to the site of the emergency.
